(19) United States
(12) Patent Application Publication
(10) Pub. No.: US 2026/0129716 A1
(43) Pub. Date: May 7, 2026

(54) METHOD FOR WIRELESS COMMUNICATIONS, TERMINAL DEVICE, AND NETWORK DEVICE

(71) Applicant: QUECTEL WIRELESS SOLUTIONS CO., LTD., Shanghai (CN)

(72) Inventors: Zheng ZHAO, Shanghai (CN); Ling LYU, Frisco, TX (US)

(21) Appl. No.: 19/440,133

(22) Filed: Jan. 5, 2026

Related U.S. Application Data
(63) Continuation of application No. PCT/CN2024/113206, filed on Aug. 19, 2024.

(51) Int. Cl. H04W 76/40; H04B 7/06

(52) U.S. Cl. CPC H04W 76/40; H04B 7/0626

(57) ABSTRACT

A method for wireless communications, a terminal device, and a network device are provided. One example method includes: determining second information based on first information, wherein the first information is associated with direction, and the second information indicates a reception direction of a synchronization signal block/physical broadcast channel (SS/PBCH) block (SSB).

### CROSS-REFERENCE TO RELATED APPLICATIONS

This application is a continuation of International Application No. PCT/CN2024/113206, filed on Aug. 19, 2024, the disclosure of which is hereby incorporated by reference in its entirety.

### TECHNICAL FIELD

The present application relates to the technical field of communications, and more specifically, to a method for wireless communications, a terminal device and a network device.

### BACKGROUND

A synchronization signal block/physical broadcast channel block (SS/PBCH block, or SSB) is transmitted by means of beam sweeping. Typically, multiple SSBs are transmitted within a cell in order to complete one round of beam sweeping, so as to allow the SSBs to cover the entire service area of the cell. These SSBs are associated with respective SSB indexes. A terminal device can detect a SSB based on the corresponding SSB index. Therefore, how the terminal device obtains the SSB index becomes a problem to be solved.

### SUMMARY

A method for wireless communications, a terminal device and a network device are provided in the present application. Descriptions of various aspects involved in the present application are provided below.

In a first aspect, a method for wireless communications is provided. The method includes: determining, by a terminal device based on first information, second information. The first information is associated with direction, and the second information indicates a reception direction of an SSB.

In a second aspect, a method for wireless communications is provided. The method comprises: transmitting, by a network device, an SSB to a terminal device. A reception direction of the SSB is indicated by second information, the second information is determined based on first information, and the first information is associated with direction.

In a third aspect, a terminal device is provided. The terminal device comprises: a processing unit for determining second information based on first information. The first information is associated with direction, and the second information indicates a reception direction of an SSB.

In a fourth aspect, a network device is provided. The network device comprises: a transceiver unit for transmitting an SSB to a terminal device. A reception direction of the SSB is indicated by second information, the second information is determined based on first information, and the first information is associated with direction.

In a fifth aspect, a terminal device is provided. The terminal device comprises a transceiver, a memory, and a processor. The memory is configured to store a program. The processor is configured to invoke the program stored in the memory and control the transceiver to receive or transmit a signal, to cause the terminal device to perform the method as described in the first aspect.

In a sixth aspect, a network device is provided. The network device comprises a transceiver, a memory, and a processor. The memory is configured to store a program. The processor is configured to invoke the program stored in the memory and control the transceiver to receive or transmit a signal, to cause the network device to perform the method as described in the second aspect.

In a seventh aspect, an apparatus is provided. The apparatus comprises a processor for invoking a program from a memory, to cause the apparatus to perform the method as described in the first aspect or the second aspect.

In an eighth aspect, a chip is provided. The chip comprises a processor for invoking a program from a memory, to cause a device incorporating the chip to perform the method as described in the first aspect or the second aspect.

In a ninth aspect, a computer-readable storage medium is provided. The computer-readable storage medium has stored thereon a program which causes a computer to perform the method as described in the first aspect or the second aspect.

In a tenth aspect, a computer program product is provided. The computer program product includes a program which causes a computer to perform the method as described in the first aspect or the second aspect.

In an eleventh aspect, a computer program is provided. The computer program causes a computer to perform the method as described in the first aspect or the second aspect.

In the embodiments of the present application, a terminal device can determine second information based on first information associated with direction, and further acquire a reception direction of an SSB based on the second information, to detect the SSB.

### BRIEF DESCRIPTION OF THE DRAWINGS

FIG. 1 is a schematic diagram illustrating a system architecture of a wireless communications system applied to embodiments of the present application.

FIG. 2 is a schematic diagram illustrating carrier aggregation according to the embodiments of the present application.

FIG. 3 is a schematic diagram illustrating a development process of the carrier aggregation according to the embodiments of the present application.

FIG. 4 is a schematic structural diagram illustrating an SSB according to the embodiments of the present application.

FIG. 5 is a schematic diagram illustrating SSB beam sweeping and transmission timing of an SSB burst set according to the embodiments of the present application.

FIG. 6 is a schematic diagram illustrating a positional relationship between ta direction of SSB beam sweeping and a terminal device according to the embodiments of the present application.

FIG. 7 is a schematic diagram illustrating an approach of activating a secondary cell according to the embodiments of the present application.

FIG. 8 is a schematic diagram illustrating another approach of activating a secondary cell according to the embodiments of the present application.

FIG. 9 is a flowchart illustrating a method for wireless communications according to the embodiments of the present application.

FIG. 10 is a flowchart illustrating determination of a target SSB index according to the embodiments of the present application.

FIG. 11 is a schematic structural diagram illustrating a terminal device according to the embodiments of the present application.

FIG. 12 is a schematic structural diagram illustrating a network device according to the embodiments of the present application.

FIG. 13 is a schematic diagram illustrating a communications apparatus according to the embodiments of the present application.

### DETAILED DESCRIPTION OF THE EMBODIMENTS

The technical solutions of the present application will be described below with reference to the drawings.

### Wireless Communications System

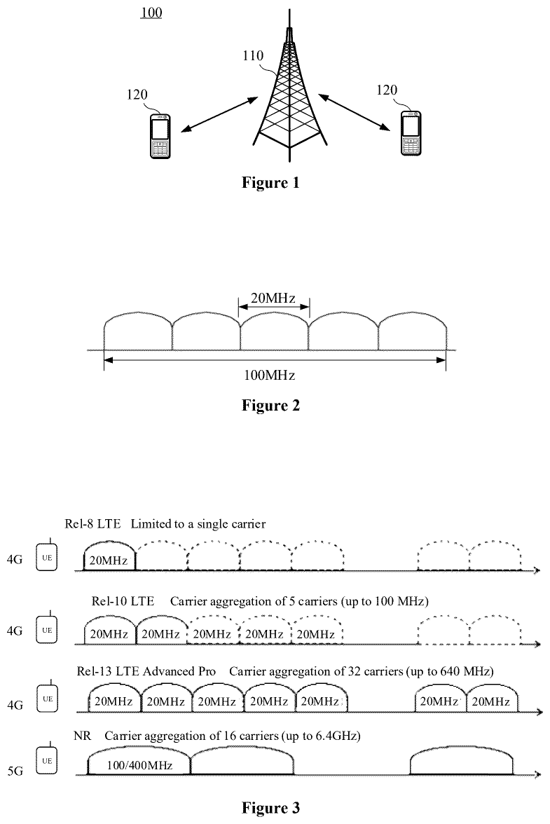

FIG. 1 is a schematic diagram illustrating a system architecture of a wireless communications system 100 applied to the embodiments of the present application. The wireless communications system 100 may include a network device 110 and terminal devices 120. The network device 110 may be a device that communicates with the terminal device 120. The network device 110 may provide network coverage for a specific geographical area and communicate with the terminal devices 120 located within the coverage area. The terminal device 120 may access a network, e.g., a wireless network, via the network device 110. Optionally, the wireless communications system 100 may also include other network entities, such as a network controller, a mobility management entity, etc., which are not specifically limited in the embodiments of the present application.

It should be understood that the technical solutions in the embodiments of the present application can be applied to various communication systems, such as a fifth-generation (5G) system or new radio (NR), a long-term evolution (LTE) system, an LTE frequency division duplex (FDD) system, an LTE time division duplex (TDD) system, and so on. The technical solutions is the present application can also be applied to a future communication system, such as a sixth-generation (6G) mobile communication system, a satellite communication system, and the like.

The terminal device in the embodiments of the present application may also be referred to as user equipment (UE), an access terminal, a user unit, a user station, a mobile station, a mobile terminal (MT), a remote station, a remote terminal, a mobile device, a user terminal, a terminal, a wireless communications device, a user agent, or a user device. The terminal device in the embodiments of the present application refers to a device that provides voice and/or data connectivity to users and can be used for connecting people, things, and machines, such as a handheld device, an in-vehicle device, and the like with wireless connectivity. In the embodiments of the present application, the terminal device may be a mobile phone, a tablet computer (Pad), a laptop, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. Optionally, the terminal device may serve as a base station. For example, the terminal device may serve as a scheduling entity, providing sidelink signals between terminal devices in vehicle to everything (V2X) or device to device (D2D) communications. For instance, a cellular phone and a vehicle may communicate with each other using sidelink signals. A cellular phone may directly communicate with a smart home device without relaying signals by a base station.

In the embodiments of the present application, the network device may be a device configured to communicate with a terminal device. The network device may be, for example, an access network device or a radio access network device. For instance, the network device may be a base station. The base station may broadly cover, or be replaced with, various terms such as: a NodeB, an evolved NodeB (eNB), a next generation NodeB (gNB), a relay station, an access point, a transmitting and receiving point (TRP), a transmitting point (TP), a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), or a positioning node. The base station may be a macro base station, a micro base station, a relay node, a donor node, or the like, or a combination thereof.

### Carrier A Mregation (CA)

In order to meet the peak data rate requirements of a single terminal device and to increase system capacity, CA technology may be used to expand the transmission bandwidth of the system. CA technology involves combining two or more carriers to form a data channel, thereby increasing data capacity. By utilizing the existing network spectrum, CA technology enables operators to provide higher data rates for both uplink (UL) and downlink (DL), thus enhancing network performance and ensuring high-quality user experience.

In a 4G system (also referred to as an LTE system), 2 to 5 LTE member or component carriers (CC) may be aggregated to achieve a higher transmission bandwidth, such as a maximum transmission bandwidth of 100 MHz, thereby effectively increasing the transmission rates for uplink and downlink. For example, as shown in FIG. 2, five 20 MHz carriers may be aggregated to form a transmission bandwidth of 100 XMz. The terminal device may determine, based on its capability, the number of carriers that can be simultaneously used for uplink and downlink transmission.

In the LTE system, CA technology supports both contiguous and non-contiguous carrier aggregation. Each carrier can utilize up to 110 resource elements (RE). Each terminal device uses an independent hybrid automatic repeat request (HARQ) entity on each carrier, and each RE can be mapped to only one specific carrier. The physical downlink control channel (PDCCH) on each carrier is independent, and may reuse the design of Release 8 (Rel-8/R8) of LTE. That is, the PDCCH of each carrier can be used to allocate resources for a physical downlink shared channel (PDSCH) and a physical uplink shared channel (PUSCH) of that carrier. Alternatively, a PDCCH on one carrier may schedule the uplink and downlink resource allocations for multiple carriers by using a carrier indicator field (CIF).

In Release 10 (Rel-10/R10) of LTE, the number of carriers that can be aggregated was increased, for example, supporting aggregation of up to five carriers. Furthermore, carrier aggregation has been continuously evolved in subsequent releases. For instance, as shown in FIG. 3, the carrier aggregation capability has been further enhanced in a 5G system.

The 5G system (also referred to as the New Radio (NR) system) is rooted in the protocol standards of LTE and Wi-Fi, and represents an entirely new radio interface and radio access network. The 5G system leverages the best technologies and approaches from the LTE system to meet the new requirements proposed by various standardization organizations. CA technology has played a significant role in improving user data throughput in the LTE system and is expected to play an equally important role in the 5G system. In order to increase capacity, operators worldwide are actively introducing additional CA frequency bands and functionalities. For example, as shown in Table 1, different countries and regions have designed corresponding CA types and functions for different frequency bands.

TABLE 1

| Region | Frequency Band | CA Type and Function |
|---|---|---|
| Europe | B1 [symbol] B3 [symbol] B7 [symbol] B8 [symbol] B20 [symbol] | 5CC_CA [symbol] |
| | B28 [symbol] B32 [symbol] B38 [symbol] B40 | UL 2CC_CA |
| China | B1 [symbol] B3 [symbol] B5 [symbol] B8 [symbol] B34 [symbol] | 5CC_CA [symbol] |
| | B39 [symbol] B40 [symbol] B41 | UL 2CC_CA |
| South | B1 [symbol] B3 [symbol] B5 [symbol] B7 [symbol] B8 | 5CC_CA [symbol] |
| Korea | | UL 2CC_CA |
| Japan | B1 [symbol] B3 [symbol] B11 [symbol] B18 [symbol] B19 [symbol] | 5CC_CA [symbol] |
| | B21 [symbol] B26 [symbol] B28 [symbol] B41 [symbol] B42 | UL 2CC_CA |
| Australia | B1 [symbol] B3 [symbol] B5 [symbol] B7 [symbol] B8 [symbol] | 5CC_CA [symbol] |
| | B28 [symbol] B40 | UL 2CC_CA |
| United | B2/25 [symbol] B4/66 [symbol] B5 [symbol] B7/B12 [symbol] | 5CC+_CA [symbol] |
| States | B13 [symbol] B14 [symbol] B26 [symbol] B30 [symbol] B41 [symbol] | UL 2CC_CA |
| | B46 [symbol] B48 [symbol] B70 [symbol] B71 | |

Since the introduction of CA technology in the LTE-Advanced protocol derived from the 4G system, carrier aggregation initially involved five carriers, each having a bandwidth of 20 MHz, resulting in a total bandwidth of 100 MHz after aggregation. Subsequently, carrier aggregation evolved to support 32 carriers, with a total bandwidth of up to 640 MHz after aggregation. With the advancement of communication technologies, the number of carriers that can be aggregated in the 5G system has gradually increased to 16, with each carrier having a larger bandwidth. In a Sub-6 GHz system, the bandwidth of a single carrier can reach up to 100 MHz, allowing 16 carriers to be aggregated into a total bandwidth of 1.6 GHz. In the millimeter wave frequency band, the bandwidth of a single carrier can reach up to 400 MHz, and aggregation of 16 carriers can result in a total bandwidth of 6.4 GHz.

As mentioned earlier, when multiple carriers are aggregated to work together, coordination between them is required. Therefore, these carriers are classified into primary carriers and secondary carriers. The primary carrier is used to carry signaling and manage the other carriers, and the primary carrier can also be referred to as the primary cell (PCell). The secondary carrier is used to extend the bandwidth and enhance the data rate, and its addition or removal is determined by the primary carrier. The secondary carrier can also be referred to as the secondary cell (SCell). The primary and secondary carriers are defined relative to the terminal device. For different terminal devices, the primary and secondary carriers used for their operation may differ. Furthermore, the multiple carriers involved in aggregation are not limited to the same base station. For example, these carriers may come from neighboring base stations.

### SSB

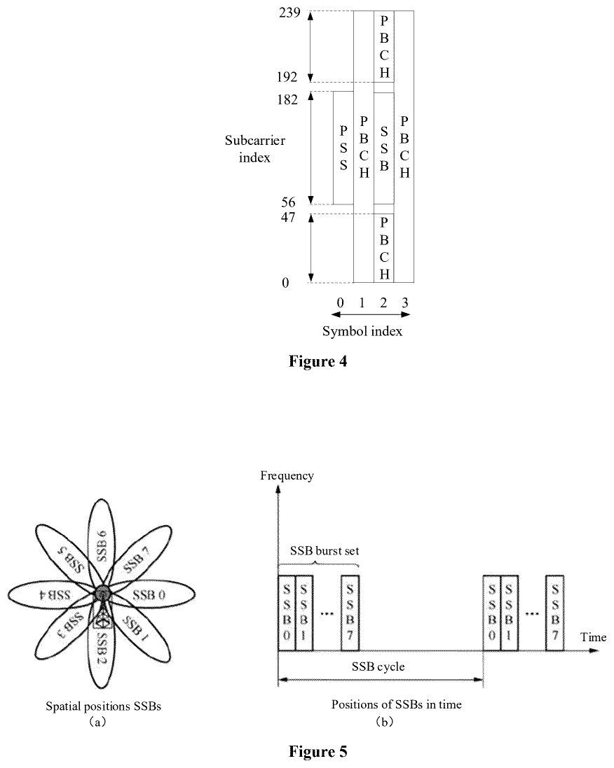

In the NR system, each SSB is used for initial access and synchronization. An SSB consists of three parts: a primary synchronization signal (PSS), a secondary synchronization signal (SSS), a physical broadcast channel (PBCH). For example, as shown in FIG. 4, the SSB occupies 4 OFDM symbols in the time domain and 240 subcarriers in the frequency domain, corresponding to 20 physical resource blocks (PRBs), with numbering ranging from 0 to 239.

The SSB is transmitted through beam sweeping, and multiple SSBs are typically transmitted to complete one round of beam sweeping within a cell, in order to cover the entire service area of the cell. The SSBs for completing one round of beam sweeping form an SSB burst set, or simply an SSB burst. The transmission configuration of the SSB burst set in time, frequency, or spatial domain is typically described by the pattern of the SSB burst set. For example, as shown in FIG. 5, (a) shows the spatial beams for transmitting each SSB, and (b) shows the time domain position for transmitting each SSB.

Depending on the frequency band and configuration, the pattern of the SSB burst set may vary. For instance, under different frequency bands, the maximum number of SSBs in an SSB burst set may be 4, 8, or 64, with these SSBs having distinct SSB indexes. FIG. 5 is an example where the SSB burst set includes 8 SSBs, indexed from SSB 0 to SSB 7. For example, Table 2 shows the transmission pattern information for SSBs under different sub-carrier space (SCS) configurations.

TABLE 2

| | | Index of the First Symbol | |
|---|---|---|---|
| Transmission | SSB SCS | of the SSB in the Wireless | |
| Mode | (kHz) | Frame | Description |
| A | 15 | {2, 8} + 14n | |
| B | 30 | {4, 8, 16, 20} + 28n | Frequencies ≤ 3 GHz, n = 0, 1 |
| | | | 3 GHz < frequency ≤ 6 GHz, n = 0, 1, 2, 3 |
| C | 30 | {2, 8} + 14n | Frequency Division Duplex (FDD): |
| | | | Frequencies ≤ 3 GHz, n = 0, 1 |
| | | | 3 GHz < Frequency ≤ 6 GHz, n = 0, 1, 2, 3 |
| | | | Time Division Duplex (TDD): |
| | | | Frequencies ≤ 2.4 GHz, n = 0, 1 |
| | | | 2.4 GHz < Frequency ≤ 6 GHz, n = 0, 1, 2, |
| | | | 3 |
| D | 120 | {4, 8, 16, 20} + 28n | Frequency > 6 GHz, |
| | | | n = 0, 1, 2, 3, 5, 6, 7, 8, 10, 11, 12, 13, 15, 16, 17, 18 |
| E | 240 | {8, 12, 16, 20, 32, 36, 40, | Frequency > 6 GHz, n = 0, 1, 2, 3, 5, 6, 7, 8 |
| | | 44} + 56n | |

The terminal device can obtain synchronization through the SSB transmitted by the primary cell and perform radio resource management (RRM) measurements. To save time-frequency resources and reduce power consumption by the base station, the SSB may not be transmitted in the secondary cell. However, in some cases, due to different measurement requirements in the secondary cell compared to the primary cell, the SSB may be transmitted in such secondary cell.

Since transmitting an SSB by the terminal device results in relatively high energy consumption, for energy-saving purposes, the SSB in the secondary cell should not be transmitted continuously but should be transmitted on demand. In other words, the network device can configure the SSB for short-term transmission, meaning that the SSB transmission in the secondary cell occurs only for a specific period, which can be determined based on needs of the terminal device. This type of SSB is referred to as an on-demand SSB.

The difference between the on-demand SSB and the conventional SSB is that the conventional SSB is transmitted periodically, whereas the on-demand SSB is transmitted within a specific period, i.e., transmitted only during the required time. That is, the transmission resources for the on-demand SSB are dynamically or semi-statically scheduled.

The SSB described in the embodiments of the present application may include both the conventional SSB and the on-demand SSB. A terminal device that supports on-demand SSBs can receive the on-demand SSB transmitted by the network device, while a terminal device that do not support the on-demand SSB cannot be aware that the network device has transmitted an on-demand SSB and can only detect the conventional SSB. Here, the terminal device that supports on-demand SSBs may, for example, be a terminal device supporting higher protocol versions, such as a terminal device in NR Release 19 and subsequent versions. A terminal device that does not support on-demand SSBs may, for example, be a terminal device supporting lower protocol versions, such as a terminal device in NR Release 18 and earlier versions.

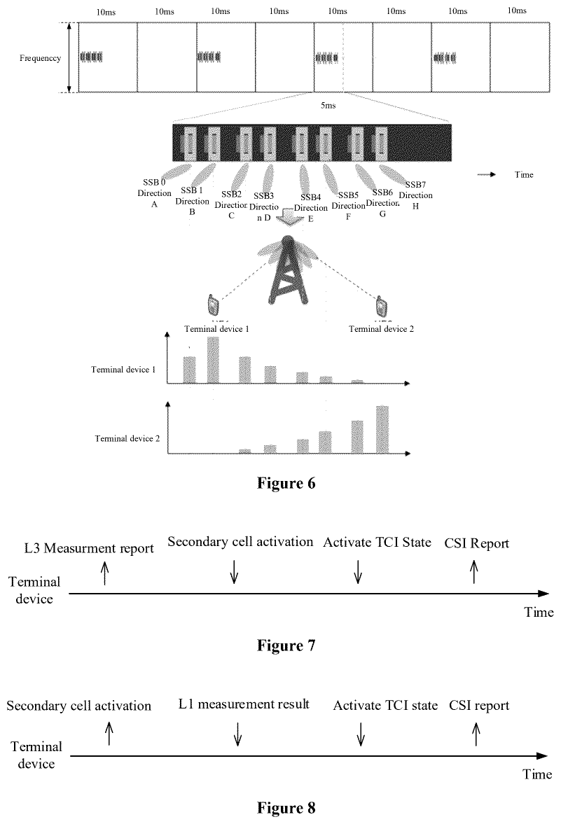

As described above, the SSB is transmitted by means of beam sweeping. For example, as shown in FIG. 6, an SSB burst set including eight SSBs whose SSB indexes are SSB 0, SSB 1, SSB 2, SSB 3, SSB 4, SSB 5, SSB 6, and SSB 7, respectively. Since the eight SSBs with respective indexes SSB 0 to SSB 7 correspond to distinct directions, the SSB with the best signal quality for a terminal device may vary depending on the location of the device within the cell. As shown in FIG. 6, using a terminal device 1 and a terminal device 2 as examples, for the terminal device 1, the SSB received in the direction corresponding to the index SSB 1 has the best signal quality. Therefore, the terminal device 1 can receive the SSB in the direction corresponding to the index SSB 1, i.e., receive the SSB with the index SSB 1. For terminal device 2, the SSB received in the direction corresponding to the index SSB 7 has the best signal quality. Therefore, the terminal device 2 can receive the SSB in the direction corresponding to the index SSB 7, i.e., receive the SSB with the index SSB 7.

Typically, the network device may transmit the corresponding SSB index to the terminal device, so that the terminal device can know an SSB from which direction to receive. However, in some cases, the network device fails to transmit the SSB index to the terminal device in time, which may affect detection of the SSB by the terminal device. Specific examples will be described below with reference to FIGS. 7 and 8.

FIGS. 7 and 8 illustrate the process of activating a secondary cell. FIG. 7 shows the activation process of a secondary cell in a case where the measurement result of the currently known secondary cell is available. FIG. 8 shows the activation process of a secondary cell in a case where the measurement result of the secondary cell is currently unknown. Regardless of whether the measurement result of the secondary cell is known, the activation of the secondary cell can be considered complete after the terminal device reports valid channel state information (CSI).

As shown in FIG. 7, if the terminal device has sent a measurement report to the network device within a certain period before receiving the activation signaling of the secondary cell, the network device can obtain the measurement result of the terminal device in advance. In this way, upon receiving the activation signaling of the secondary cell by the terminal device, the network device can quickly determine the transmission configuration indication (TCI) state for further data transmission and send it to the terminal device. In this case, upon receiving the activation signaling of the secondary cell, the terminal device can perform channel measurement and report the CSI. The measurement result shown in FIG. 7 may, for example, be a result of radio resource management (RRM) measurement. The terminal device may obtain the corresponding measurement result based on the detection of the SSB and generate a measurement report. The measurement result includes, but is not limited to, the measurement results of parameters such as reference signal receiving power (RSRP), reference signal receiving quality (RSRQ), and signal to interference noise ratio (SINR). Further, the measurement result may, for example, be a Layer 3 (L3) cell-level measurement result, a Layer 3 beam-level measurement result, a Layer 1 (L1) cell-level measurement result, or a Layer 1 beam-level measurement result.

As shown in FIG. 8, if the terminal device has not generated the above-mentioned measurement report before receiving the activation signaling of the secondary cell, the terminal device needs to perform operations such as automatic gain control (AGC), synchronization, and measurement reporting based on the SSB upon receiving the activation signaling of the secondary cell. The measurement result may, for example, be a Layer 1 (L1) (physical layer) cell-level measurement result or a Layer 1 beam-level measurement result. The network device then determines the TCI state to be activated based on the measurement result reported by the terminal device and sends the TCI state to the terminal device.

In the case shown in FIG. 7, the network device has already obtained a measurement report sent by the terminal device, such as a Layer 3 and/or Layer 1 measurement report, before activating the secondary cell, the network device can determine the optimal beam based on the measurement report. Accordingly, the network device may select the corresponding SSB index from the SSB burst set and notify the terminal device of the selected SSB index corresponding to the optimal beam. For example, the network device may notify the terminal device of the SSB index corresponding to the SSB to be transmitted in the activation signaling of the secondary cell. In this way, the terminal device can perform detection based on the SSB corresponding to the index to complete fine synchronization with the secondary cell.

In the case shown in FIG. 8, the network device has not obtained a measurement report sent by the terminal device, such as a Layer 1 measurement report, when activating the secondary cell, the network device cannot determine the optimal beam when sending the activation signaling of the secondary cell. In certain cases, even if the network device receives the measurement report at the time of sending the activation signaling, the network device may not have completed the decoding and parsing of the measurement result when determining the activation signaling. In such a case, the network device still cannot promptly notify the terminal device of the SSB index corresponding to the SSB to be transmitted. As a result, the terminal device cannot perform detection based on the SSB corresponding to the index, and therefore cannot complete fine synchronization with the secondary cell.

In view of this, a method for wireless communications is provided according to an embodiment of the present application. By this method, a terminal device can determine second information based on first information associated with direction, and further obtain a reception direction of an SSB based on the second information, to perform detection of the SSB.

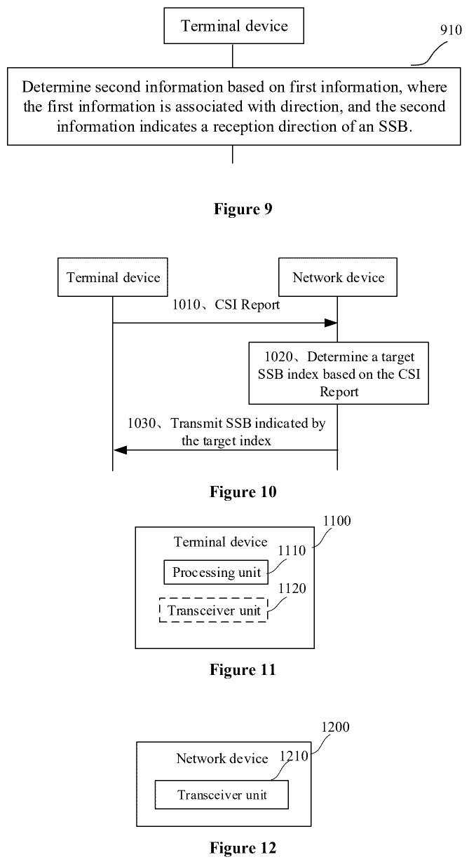

The embodiments of the present application are described in detail below with reference to FIG. 9.

FIG. 9 is a schematic flowchart of the method for wireless communications according to an embodiment of the present application. As shown in FIG. 9, in step 910, the terminal device determines second information based on first information.

The second information is used to determine (or indicate) the reception direction of an SSB, i.e., the direction in which the terminal device receives or detects the SSB.

The first information is associated with direction. For example, the first information may be directional. For example, a value of the first information differs depending on the direction, or the first information may carry direction information.

The SSB described in the embodiments of the present application may, for example, be an on-demand SSB.

Since the terminal device can determine second information based on first information associated with direction and thereby obtain the reception direction of the SSB, the terminal device can perform timely detection of the SSB even without receiving the SSB index transmitted by the network device.

In this case, the network device may refrain from transmitting the SSB index to the terminal device. Alternatively, the network device may transmit the SSB index to the terminal device, and the terminal device may perform SSB detection based on the reception direction of the SSB determined by itself, before the SSB index is transmitted.

The second information described in step 910 may, for example, include the reception direction and/or the SSB index of the SSB. That is, the terminal device can directly determine the reception direction of the SSB based on the first information. Alternatively, the terminal device may determine information related to the reception direction of the SSB based on the first information, e.g., the SSB index or the direction corresponding to the SSB index, where the direction corresponding to the SSB index may, for example, be considered as the reception direction of the SSB.

The direction corresponding to the SSB index may, for example, be the direction of the SSB indicated by the SSB index. For example, as shown in FIGS. 5 and 6, the eight SSBs with indices SSB 0 to SSB 7 have distinct positions in the spatial domain, i.e., the eight SSBs represented by SSB 0 to SSB 7 are located in distinct directions. Therefore, the directions corresponding to indices SSB 0 to SSB 7 are the directions of the respective SSBs. For example, as shown in FIG. 6, the direction corresponding to SSB 0 is a direction A, meaning that the SSB with index SSB 0 is directed towards the direction A in the spatial domain. The direction corresponding to SSB 1 is a direction B, meaning that the SSB with the index SSB 1 is directed towards the direction B in the spatial domain. The direction corresponding to SSB 2 is a direction C, meaning that the SSB with the index SSB 2 is directed towards the direction C in the spatial domain. The direction corresponding to SSB 3 is a direction D, meaning that the SSB with the index SSB 3 is directed towards the direction D in the spatial domain. The direction corresponding to SSB 4 is a direction E, meaning that the SSB with the index SSB 4 is directed towards the direction E in the spatial domain. The direction corresponding to SSB 5 is a direction F, meaning that the SSB with the index SSB 5 is directed towards the direction F in the spatial domain. The direction corresponding to SSB 6 is a direction G, meaning that the SSB with the index SSB 6 is directed towards the direction G in the spatial domain. The direction corresponding to SSB 7 is a direction H, meaning that the SSB with the index SSB 7 is directed towards a direction H in the spatial domain.

As described above, the first information is used to determine the second information, and the second information is used to determine the reception direction of the SSB. The second information can be used to determine the reception direction of a single SSB, in which case the terminal device detects the SSB in that direction. Alternatively, the second information can be used to determine multiple reception directions, in which case the terminal device performs SSB detection in multiple reception directions. That is, the terminal device can obtain one or more reception directions based on the first information in order to perform SSB detection.

In the embodiments of the present application, the first information may, for example, include CSI and/or TCI state, which are separately described in detail below.

### The First Information Includes CSI.

CSI is used to describe the channel state (or channel properties) of the communication link. For example, CSI may include the attenuation factor on each transmission path, such as signal scattering, environmental attenuation (including multipath fading, shadow fading, etc.), distance attenuation, and other information. These details are used to assess and characterize the communication channel, for the terminal device and network device to make intelligent adjustments and decisions during communication.

CSI may be information associated with direction. For example, the CSI information may include the channel characteristics in various directions between the terminal device and the network device, such characteristics including but not limited to signal amplitude, signal phase, and other information, which together describe the distribution of the signal in space. Since the channel characteristics in each direction between the terminal device and the network device are different, the CSI information can reflect the transmission conditions of the signal in different directions. That is, the CSI information implicitly contains the directionality of the signal in space.

In some embodiments, the second information may include the direction of the channel whose channel state, as indicated by the CSI, satisfies predetermined conditions. Here, the predetermined condition may, for example, be an optimal channel state or a parameter value representing the channel state being greater than a threshold. For example, the terminal device performs detection and obtains corresponding CSI information, which may include the channel state in different directions. The terminal device can select the direction with the optimal channel state as the direction for receiving the SSB. The SSB is transmitted by beam sweeping, this can reduce the complexity of receiving the beam sweeping. Here, receiving beam sweeping refers to the process in which the terminal device receives the signal with different beams at different times and selects the final beam for receiving the SSB based on the beam that provides the highest measured power.

Referring to FIG. 6, if the detected CSI indicates that the channel state in the direction B is optimal, the terminal device 1 can receive the SSB transmitted by the network device in from the direction B, where the SSB index in the direction B is SSB 1. If the detected CSI indicates that the channel state in the direction H is optimal, the terminal device 2 can receive the SSB transmitted by the network device from the direction H, where the SSB index in the direction H is SSB 7.

It should be noted that the CSI referred to in the embodiments of the present application, for example, refers to valid CSI. The valid CSI may, for example, refer to CSI that is actually usable or CSI that has a positive impact on system performance.

### The First Information Includes the TCI State.

The TCI state may be used to describe the quasi-co-location (QCL) relationship between reference signals, such as the QCL relationship between a downlink reference signal (e.g., SSB) and a demodulation reference signal (DMSR) for PDSCH. The TCI state provides the necessary spatial domain characteristic information for the terminal device to receive the physical channel, so that the terminal device can perform channel estimation and decoding properly.

The TCI state can be considered as information associated with direction. Typically, the TCI state may directly or indirectly indicate which beam direction the terminal device can use to receive or transmit signals. For example, if the DMRS for PDSCH is configured to have a QCL relationship with a downlink reference signal (e.g., SSB), it means that the beam direction of PDSCH is similar to or the same as the beam direction of the downlink reference signal (e.g., SSB).

In some embodiments, the second information can be determined based on the direction information carried in the TCI state. For example, the direction information carried in the TCI state may include one or more of the following: an SSB index, direction information of a channel state information reference signal (CSI-RS), a beam direction, an antenna port, direction information of DMRS, or the like.

For example, the SSB is a source reference symbol, and the TCI information includes the SSB index, then the second information may include the SSB index, and the direction corresponding to the SSB index may be used as the reception direction of the SSB.

For another example, the TCI information includes the beam direction, which indicates which beam the terminal device should use to receive the downlink signal or downlink channel. For instance, the beam direction carried in the TCI state corresponds to a specific SSB index, then the second information may include the SSB index, and the direction corresponding to the SSB index can be used as the reception direction of the SSB.

For another example, the TCI information includes information about the antenna port, which is used for downlink channel transmission. Different antenna ports may correspond to different transmission directions, then the second information can include the direction corresponding to the antenna port carried in the TCI state, and the direction corresponding to the antenna port can be used as the reception direction of the SSB.

For another example, the TCI information includes the QCL relationship between the DMRS and a downlink reference signal. The QCL relationship between the DMRS and a downlink reference signal (e.g., SSB) typically implies that the beam direction of the DMRS is similar to or the same as that of the downlink reference signal (e.g., SSB), and the TCI state indicates that the direction of the DMRS corresponds to a specific SSB index, then the second information may include the SSB index, and the direction corresponding to the SSB index can be used as the reception direction of the SSB.

In some implementations, the TCI state may include one or more of the following: a TCI state corresponding to the PDCCH, a TCI state corresponding to the PDSCH, or a TCI state corresponding to a channel status information reference signal (CSI-RS).

The above-mentioned TCI state may be indicated by the network device. For example, the network device may send a TCI activation indication (e.g., carried in a MAC CE) to inform the terminal device of the currently activated TCI state. In other words, the TCI state may be one of the TCI states in a TCI state list (e.g., typically including 128 TCI states) that has been activated. The TCI state list may, for example, be configured for the terminal device by the network device through RRC signaling.

In some implementations, the network device may further restrict the range of SSB indexes. For example, as shown in FIG. 6, the range of SSB indexes may be narrowed from SSB 0 to SSB 7. For instance, the range of SSB indexes used by the terminal device 1 may be further restricted to SSB 0 to SSB 2, and the range of SSB indexes used by the terminal device 2 may be further restricted to SSB 6 to SSB 7. These SSB indexes may be referred to as candidate SSB indexes. The number of candidate SSB indexes may be one or more.

In some implementations, the terminal device resides in a secondary cell, information about the candidate SSB index may be determined based on the directional information of the terminal device relative to the secondary base station corresponding to the secondary cell.

In some implementations, the directional information of the terminal device relative to the secondary base station may be determined based on one or more of the following: location information of a primary base station corresponding to a primary cell where the terminal device resides, directional information of the terminal device relative to the primary base station, or location information of the secondary base station corresponding to the secondary cell. That is, the network device can determine the direction of the terminal device relative to the secondary base station based on the positions of the primary base station and the secondary base station, as well as the direction of the terminal device relative to the primary base station. Then, the network device can determine multiple candidate SSB indexes based on the direction of the terminal device relative to the secondary base station.

In some implementations, after determining the candidate SSB indexes, the network device may transmit information related to the candidate SSB indexes to the terminal device. Correspondingly, the terminal device receives information related to the candidate SSB indexes from the network device. For example, information related to the candidate SSB indexes may be carried in one or more of the following: configuration information of the SSB transmitted by the network device, activation information of the SSB transmitted by the network device, configuration information of the secondary cell transmitted by the network device, or activation information of the secondary cell transmitted by the network device.

The activation information of the SSB is used to determine the transmission timing of the SSB, i.e., when the SSB is activated. For example, the activation information of the SSB may be carried in the configuration information of the SSB; and/or, the activation information may be transmitted by the network device to the terminal device after the configuration information of the SSB; and/or, the activation information may be predefined.

The configuration information of the SSB may, for example, configuration information of an on-demand SSB. Optionally, the configuration information of the SSB may include one or more of the following: frequency information of the SSB, time domain information of the SSB burst set, information indicating the SSB positions within the SSB burst set that are used for actual transmission, periodicity information of the SSB, subcarrier space of the SSB, bandwidth of the SSB, downlink transmission power of the SSB, cell identifier (e.g., secondary cell identifier), or information related to the candidate SSB indexes.

The activation information of the SSB may include one or more of the following: activation indication information indicating activation of the SSB, deactivation indication information indicating deactivation of the SSB, information indicating the SSB transmission start time, information indicating the SSB transmission end time, information indicating a duration of the SSB transmission, secondary cell state (SCellState) information in the configuration information of the secondary cell (e.g., SCellState set to active indicates SSB activation, or set to deactivation indicates the SSB is not activated), periodicity information of the SSB, or information related to the candidate SSB indexes.

Optionally, the activation information of the SSB may be carried in the configuration information of the SSB, the configuration information of the secondary cell, or the activation information of the secondary cell; and/or, the activation information of the SSB may be transmitted by the network device to the terminal device independently of the above configuration information (e.g., transmitted after the above configuration information); and/or, the activation information of the SSB may be predefined (e.g., as specified by the protocol).

In step 910, the reception direction determined by the terminal device corresponds to directions indicated by one or more of the candidate SSB indexes. In other words, the terminal device may receive SSBs based on multiple candidate SSB indexes provided by the network device, for example, by performing SSB detection in all directions corresponding to the multiple candidate SSB indexes. Alternatively, the terminal device may select one SSB index from the candidate SSB indexes and receive the SSB in the direction corresponding to the selected index, thereby reducing the detection complexity. For example, the terminal device determines second information based on first information, where the second information includes an SSB index. The SSB index is one of the candidate SSB indexes, and the direction corresponding to the SSB index is used as the reception direction for the SSB.

In some implementations, the terminal device may transmit a CSI report to the network device. The CSI report is used to determine a target SSB index, for example, from the candidate SSB indexes. In other words, upon receiving the CSI report from the terminal device, the network device determines the target SSB index among multiple SSB indexes based on the CSI report, and transmits the SSB indicated by the target SSB index. That is, the SSB index of the SSB transmitted by the network device to the terminal device is the target SSB index determined from the candidate SSB indexes by the network device based on the CSI report transmitted by the terminal device.

For example, as illustrated in FIG. 10, in step 1010, the terminal device transmits a CSI report to the network device. In step 1020, the network device determines a target SSB index from the candidate SSB indexes based on the CSI report. In step 1030, the network device transmits the SSB indicated by the target SSB index to the terminal device.

Here, the target SSB index refers to the SSB index used by the network device to transmit the SSB. As described above, the second information may include one or more SSB indexes, which are used for the terminal device to receive the SSB. These SSB indexes may, for example, serve as the reception directions of the SSB. The target SSB index may be one of these SSB indexes included in the second information.

As described above, the terminal device may determine second information based on first information and obtain the reception direction of the SSB from the second information. The terminal device may perform SSB detection in the reception direction. However, the terminal device may be unable to determine the SSB index (e.g., the specific index value) of the SSB received in the reception direction. The SSB index may be required in other scenarios, for example, during subsequent uplink transmissions. Therefore, in some implementations, the network device may transmit a correspondence between SSB indexes and SSB reception directions to the terminal device. Correspondingly, the terminal device receives the correspondence between SSB indexes and SSB reception directions from the network device. This correspondence is used to determine the SSB index corresponding to the reception direction.

In other words, after obtaining the reception direction of the SSB, the terminal device may determine the SSB index of the SSB in the reception direction based on the reception direction and the correspondence between SSB indexes and reception directions.

Referring to FIG. 6, assuming that the SSB indexes include SSB 0, SSB 1, SSB 2, SSB 3, SSB 4, SSB 5, SSB 6, and SSB 7, and the correspondence is as follows: SSB 0, SSB 1, SSB 2, SSB 3, SSB 4, SSB 5, SSB 6, and SSB 7 correspond to a direction A, a direction B, a direction C, a direction D, a direction E, a direction F, a direction G, and a direction H, respectively. For example, the reception direction of the SSB determined by the terminal device 1 is the direction B. Based on the above correspondence, the terminal device 1 determines that the SSB index corresponding to the direction B is SSB 1. Therefore, the terminal device 1 can obtain both the reception direction of the SSB and the SSB index corresponding to the SSB in that direction.

Similarly, if the reception direction of the SSB determined by the terminal device 2 is the direction H, then the terminal device 2 may determine, based on the above correspondence, that the SSB index corresponding to the direction H is SSB 7. Therefore, the terminal device 2 can also obtain the reception direction of the SSB and the SSB index corresponding to the SSB in that direction.

The method embodiments of the present application have been described in detail above with reference to FIGS. 1 through 10. The following will describe in detail the apparatus embodiments of the present application with reference to FIGS. 11 through 13. It should be understood that the descriptions of the method embodiments correspond to those of the apparatus embodiments, and therefore, portions not described in detail may be referenced from the foregoing method embodiments.

FIG. 11 is a schematic structural diagram of a terminal device according to an embodiment of the present application. As shown in FIG. 11, the terminal device 1100 may include a processing unit 1110. The processing unit 1110 is configured to determine second information based on first information. The first information is associated with direction, and the second information is used to indicate a reception direction of an SSB.

In some implementations, the second information includes: the reception direction of the SSB; and/or an SSB index of the SSB.

In some implementations, the first information includes channel state information CSI.

In some implementations, the second information includes a direction of a channel with the optimal channel state as indicated by the CSI.

In some implementations, the first information includes a transmission configuration indication TCI state.

In some implementations, the second information is determined based on direction information carried in the TCI state.

In some implementations, the direction information carried in the TCI state includes one or more of the following: an SSB index, direction information of a channel state information reference signal CSI-RS, beam information, or antenna port information.

In some implementations, the terminal device 1100 further includes a transceiver unit 1120 for sending a channel state information CSI report to the network device. The CSI report is used by the network device to determine a target SSB index. The SSB index transmitted by the network device is the target SSB index.

In some implementations, the target SSB index is one or more indexes from candidate SSB indexes.

In some implementations, the terminal device 1100 further includes a transceiver unit 1120 for receiving information related to candidate SSB indexes transmitted by the network device. The reception direction corresponds to one or more indexes from the candidate SSB indexes.

In some implementations, the information related to the candidate SSB indexes is carried in one or more of the following: configuration information of the SSB transmitted by the network device, activation information of the SSB transmitted by the network device, configuration information of the secondary cell transmitted by the network device, or activation information of the secondary cell transmitted by the network device.

In some implementations, the terminal device 1100 further includes a transceiver unit 1120 for receiving the correspondence between the SSB indexes and the reception directions of the SSB transmitted by the network device. The correspondence is used to determine the SSB index corresponding to the reception direction.

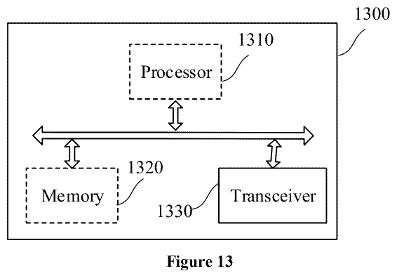

It can be understood that the processing unit 1110 can be, for example, a processor 1310, and the transceiver unit 1120 can be, for example, a transceiver 1330. Additionally, optionally, the terminal device 1100 may further include a memory 1320, as shown in FIG. 13.

FIG. 12 is a schematic structural diagram of a network device according to an embodiment of the present application. The network device 1200 shown in FIG. 12 may include a transceiver unit 1210. The transceiver unit 1210 is configured to transmit an SSB to a terminal device. a reception direction of the SSB is indicated by second information. The second information is determined based on first information, and the first information is associated with direction.

In some implementations, the second information includes at least one of a reception direction of the SSB or an SSB index of the SSB.

In some implementations, the first information includes channel state information CSI.

In some implementations, the second information includes a direction of a channel with the optimal channel state as indicated by the CSI.

In some implementations, the first information includes a transmission configuration indication TCI state.

In some implementations, the second information is determined based on direction information carried in the TCI state.

In some implementations, the direction information carried in the TCI state includes one or more of the following: an SSB index, direction information of a channel state information reference signal CSI-RS, beam information, or antenna port information.

In some implementations, the transceiver unit 1210 is further configured to receive a channel state information CSI report transmitted by the terminal device. The CSI reporting is used by the network device 1200 to determine a target SSB index, and the index of the SSB transmitted by the network device 1200 is the target SSB index.

In some implementations, the target SSB index is one or more indexes from candidate SSB indexes.

In some implementations, the transceiver unit 1210 is further configured to transmit information on candidate SSB indexes to the terminal device. The reception direction corresponds to one or more indexes from the candidate SSB indexes.

In some implementations, the terminal device is located in a secondary cell. The information on the candidate SSB indexes is determined based on location information of the terminal device relative to a secondary base station corresponding to the secondary cell.

In some implementations, the location information of the terminal device relative to the secondary base station is determined based on one or more of the following: location information of a primary base station corresponding to a primary cell of the terminal device, location information of the terminal device relative to the primary base station, or location information of the secondary base station corresponding to the secondary cell.

In some implementations, the information on the candidate SSB indices is carried in one or more of the following: configuration information of the SSB transmitted by the network device 1200, activation information of the SSB transmitted by the network device 1200, configuration information of the secondary cell transmitted by the network device 1200, or activation information of the secondary cell transmitted by the network device 1200.

In some implementations, the transceiver unit 1210 is further configured to transmit a correspondence between SSB indices and reception directions of the SSB to the terminal device, wherein the correspondence is used to determine an SSB index corresponding to the reception direction.

It can be understood that the transceiver unit 1210 may, for example, be a transceiver 1330. Optionally, the network device 1200 may further include a processor 1310 and a memory 1320, as shown in FIG. 13.

FIG. 13 is a structural diagram of a communications apparatus according to the embodiments of the present application. The dashed lines in FIG. 13 indicate that the unit or module is optional. The apparatus 1300 can perform the method described in the aforementioned method embodiments. The apparatus 1300 can be a chip, a terminal device, or a network device.

The apparatus 1300 may include one or more processors 1310. The processor 1310 can support the apparatus 1300 to perform the method described in the previous method embodiments. The processor 1310 can be a general-purpose processor or a dedicated processor. For example, the processor 1310 can be a central processing unit (CPU). Alternatively, the processor may also be another general-purpose processor, a digital signal processor (DSP), an application-specific integrated circuit (ASIC), a field-programmable gate arrays (FPGA), or other programmable logic devices, a discrete gate or transistor logic device, a discrete hardware component, etc. A general-purpose processor may be a microprocessor or any conventional processor, etc.

The apparatus 1300 may also include one or more memories 1320. The memory 1320 stores a program that can be executed by the processor 1310, causing the processor 1310 to perform the method described in the previous method embodiments. The memory 1320 can be independent of the processor 1310 or integrated within the processor 1310.

The apparatus 1300 may further include a transceiver 1330. The processor 1310 can communicate with other devices or chips via the transceiver 1330. For example, the processor 1310 can transmit date to or receive data from other devices or chips through the transceiver 1330.

A communications system is further provided according to an embodiment of the present application. The communications system includes the above-described terminal device and network device. In some implementations, the system further includes other devices that interact with the terminal device and the network device.

A computer-readable storage medium for storing a program is further provided according to an embodiment of the present application. The computer-readable storage medium can be applied to the terminal device or the network device in the embodiments of the present application, and the program causes a computer to perform the method performed by the terminal device or the network device as described in the various embodiments of the present application.

A computer program product is further provided according to an embodiment of the present application. The computer program product comprises a program. The computer program product may be applied to the terminal device or the network device in the embodiments of the present application, and the program causes a computer to perform the method performed by the terminal device or the network device as described in the various embodiments of the present application.

A computer program is further provided according to an embodiment of the present application. The computer program may be applied to the terminal device or the network device in the embodiments of the present application, and the computer program causes a computer to perform the method performed by the terminal device or the network device as described in various embodiments of the present application.

It should be understood that the terms “system” and “network” as used in the embodiments of the present application may be used interchangeably. In addition, the terminology used in the present application is only for the purpose of describing specific embodiments, and is not intended to limit the present application. The terms “first,” “second,” “third,” and “fourth,” as used in the specification, claims, and drawings of the present application, are intended to distinguish different objects and are not intended to indicate any particular order. Furthermore, the terms “comprising” and “having,” and any variations thereof, are intended to cover non-exclusive inclusion.

In the embodiments of the present application, the term “indicate” may refer to a direct indication, an indirect indication, or an indication of an association. For example, “A indicates B” may mean that A directly indicates B, such as B being obtainable from A; or that A indirectly indicates B, such as A indicating C and B being obtainable from C; or that A and B have an associated relationship.

In the embodiments of the present application, “B corresponding to A” means that B is associated with A and can be determined based on A. However, it should be understood that determining B based on A does not necessarily mean determining B solely based on A, instead may also be based on A and/or other information.

In the embodiments of the present application, the term “corresponding” may indicate a direct or indirect correspondence, an associative relationship, or a relationship such as indicating and being indicated, configuring and being configured, etc., between two elements.

In the embodiments of the present application, “predefined” or “preconfigured” may be implemented by storing corresponding code, tables, or other mechanisms capable of indicating related information in the device (e.g., including the terminal device and the network device) in advance. The present application does not limit the specific manner of implementation. For example, “predefined” may refer to definition specified in a protocol.

In the embodiments of the present application, the term “protocol” may refer to standard communication protocols in the field of communications, including, for example, the LTE protocol, the NR protocol, and relevant protocols applicable to future communication systems. The present application is not limited thereto.

In the embodiments of the present application, the term “and/or” is merely used to describe an association between related objects and represents three possible relationships. For example, “A and/or B” may indicate: A alone, both A and B, or B alone. In addition, the symbol “/” generally indicates an “or” relationship between the associated objects before and after the symbol.

In various embodiments of the present application, the numbering of the above processes does not imply any order of execution. The actual order of execution should be determined based on the functions and inherent logic of the processes, and should not be construed as limiting the implementation of the embodiments of the present application.

It should be understood that the disclosed systems, devices, and methods in the embodiments of the present application can be implemented in other ways. For example, the apparatus embodiments described above are merely illustrative. The division of the units is just based on logical functions, and different implementations may adopt other divisions. For instance, multiple units or components may be combined or integrated into another system, some features may be omitted, or may not be executed. Furthermore, the coupling or direct coupling or communication connection between the units shown or discussed can be achieved through interfaces, indirect coupling, or communication connections of the devices or units, which may be electrical, mechanical, or in other forms.

The units described as separate components may or may not be physically separate. The components displayed as units may or may not be physical units, meaning they could be located in one place or distributed across multiple network units. Depending on practical requirements, part or all of the units may be selected to achieve the objectives of the present embodiment.

Additionally, in various embodiments of the present application, the functional units may be integrated into a single processing unit, may physically exist as separate units, or may be integrated into a single unit consisting of two or more units.

The above embodiments can be achieved entirely or partially through software, hardware, firmware, or any combination thereof. When implemented by software, the above embodiments may be entirely or partially realized in the form of a computer program product. The computer program product includes one or more computer instructions. When loaded and executed on a computer, the computer program instructions generate, in whole or in part, the processes or functions described in the embodiments of the present application. The computer can be a general-purpose computer, a special-purpose computer, a computer network, or another programmable device. The computer instructions can be stored in a computer-readable storage medium, or transmitted from one computer-readable storage medium to another. For example, the computer instructions can be transmitted from a website, computer, server, or data center to another website, computer, server, or data center via wired (e.g., a coaxial cable, an optical fiber, or a digital subscriber line (DSL)) or wireless (e.g., infrared, wireless, microwave, etc.) means. The computer-readable storage medium can be any available medium that the computer can read, or a data storage device such as a server or data center that includes one or more available media. The available media may be magnetic media (e.g., a floppy disk, a hard disk, or a magnetic tape), optical media (e.g., a digital video disc (DVD)), or semiconductor media (e.g., a solid-state disk (SSD)), or the like.

The foregoing description is provided to illustrate specific embodiments of the present application and is not intended to limit the scope of the invention. Various modifications, substitutions, and changes may be made by those skilled in the art without departing from the scope and spirit of the invention as disclosed herein. Accordingly, the scope of protection of the present application should be defined by the appended claims and their equivalents.

What is claimed is:

1. A method for wireless communications, comprising:
determining, by a terminal device, second information based on first information, wherein the first information is associated with direction, and the second information indicates a reception direction of a synchronization signal block/physical broadcast channel (SS/PBCH) block (SSB).

2. The method according to claim 1, wherein the second information comprises at least one of:
the reception direction of the SSB; or
an SSB index of the SSB.

3. The method according to claim 1, wherein the first information comprises channel state information (CSI).

4. The method according to claim 3, wherein the second information comprises a direction corresponding to a channel having an optimal channel state as indicated by the CSI.

5. The method according to claim 1, wherein the first information comprises a transmission configuration indication (TCI) state.

6. The method according to claim 5, wherein the second information is determined based on direction information carried in the TCI state.

7. The method according to claim 6, wherein the direction information carried in the TCI state comprises one or more of:
an SSB index;
direction information of a channel state information-reference signal (CSI-RS);
beam information; or
antenna port information.

8. The method according to claim 1, further comprising:
transmitting, by the terminal device, a CSI report to a network device, wherein the CSI report comprises information for determining a target SSB index, and an index of an SSB transmitted by the network device is the target SSB index.

9. The method according to claim 8, wherein the target SSB index is one or more indexes from candidate SSB indexes.

10. The method according to claim 1, further comprising:
receiving, by the terminal device, information on candidate SSB indexes from a network device, wherein the reception direction corresponds to one or more indexes from the candidate SSB indexes.

11. The method according to claim 10, wherein the information on the candidate SSB indexes is carried in one or more of the:
configuration information of an SSB from the network device;
activation information of an SSB from the network device;
configuration information of a secondary cell from the network device; or
activation information of a secondary cell from the network device.

12. The method according to claim 1, further comprising:
receiving, by the terminal device, a correspondence between SSB indexes and reception directions of an SSB from a network device, wherein the correspondence is used to determine an SSB index corresponding to a respective reception direction.

13. A method for wireless communications, comprising:
transmitting a synchronization signal block/physical broadcast channel (SS/PBCH) block (SSB) to a terminal device, wherein a reception direction of the SSB is indicated by second information, the second information is determined based on first information, and the first information is associated with direction.

14. The method according to claim 13, wherein the second information comprises at least one of:
the reception direction of the SSB; or
an SSB index of the SSB.

15. The method according to claim 13, wherein the first information comprises channel state information (CSI).

16. The method according to claim 15, wherein the second information comprises a direction corresponding to a channel having an optimal channel state as indicated by the CSI.

17. The method according to claim 15, wherein the first information comprises a transmission configuration indication (TCI) state.

18. The method according to claim 17, wherein the second information is determined based on direction information carried in the TCI state.

19. The method according to claim 18, wherein the direction information carried in the TCI state comprises one or more of:
an SSB index;
direction information of a channel state information-reference signal CSI-RS;
beam information; or
antenna port information.

20. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
determining second information based on first information, wherein the first information is associated with direction, and the second information indicates a reception direction of a synchronization signal block/physical broadcast channel (SS/PBCH) block (SSB).
